(19) United States
(12) Patent Application Publication
(10) Pub. No.: US 2008/0285673 A1
(43) Pub. Date: Nov. 20, 2008

(54) Apparatus and method for reducing peak to average power ratio based on tile structure in broadband wireless communication system

(75) Inventors: Seung-Hee Han, Hwaseong-si (KR); Jong-Hyeuk Lee, Anyang-si (KR); Sang-Boh Yun, Seongnam-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/152,070

(22) Filed: May 12, 2008

(30) Foreign Application Priority Data
May 15, 2007 (KR) 2007-0047182

(51) Int. Cl. H04L 27/28

(52) U.S. Cl. 375/260

(57) ABSTRACT

A broadband wireless communication system is provided. A transmitting end of the broadband wireless communication system includes: a controller for receiving a plurality of Orthogonal Frequency Division Multiple Access (OFDMA) symbols, and for generating the same number of symbol sets corresponding to the OFDMA symbols wherein each symbol set includes a plurality of OFDMA symbols having various Peak to Average Power Ratios (PAPRs) according to several phase-shifting patterns, a selector for grouping the plurality of OFDMA symbols into symbol groups according to the same phase-shifting pattern of the several phase-shifting patterns, and for finding maximum peak value in each symbol group, and a transmitter for transmitting the symbol group having a minimum value selected from among the maximum peak values of the symbol groups.

### CROSS-REFERENCE TO RELATED APPLICATION(S) AND CLAIM OF PRIORITY

The present application claims priority under 35 U.S.C. §119(a) to a Korean patent application filed in the Korean Intellectual Property Office on May 15, 2007 and assigned Serial No. 2007-47182, the entire disclosure of which is herein incorporated by reference.

### TECHNICAL FIELD OF THE INVENTION

The present invention relates generally to a broadband wireless communication system, and in particular, to an apparatus and method for reducing a Peak to Average Power Ratio (PAPR) in a broadband wireless communication system.

### BACKGROUND OF THE INVENTION

An Orthogonal Frequency Division Multiple Access (OFDMA) transmission method is an example of a multi-carrier transmission method and is a transmission method which improves frequency efficiency by using frequency spectrum orthogonality between sub-carriers. The OFDMA transmission method provides an excellent performance in a mobile communication environment where multi-path fading exists and is used in a variety of fields such as terrestrial digital TeleVision (TV) broadcasting, digital sound broadcasting, wireless Local Access Network (LAN), and the like. Further, the OFDMA transmission method is considered as a promising candidate for a next generation wireless communication system.

However, the OFDMA transmission method has a problem in that combination of a large number of sub-carriers results in a significantly high Peak to Average Power Ratio (PAPR). The high PAPR deteriorates an efficiency of a high power amplifier located in a last stage of the transmitting end, and also results in distortion of characteristics of mutual modulation among a plurality of carriers by incurring an operation point of the amplifier to enter a non-linear region. Moreover, the high PAPR causes a serious problem in a mobile station which uses battery power and cannot use an expensive amplifier having a relatively excellent linear characteristic.

Research on reducing the PAPR has already been conducted, and as a result, various methods have been proposed. Examples of the methods proposed to reduce the PAPR include a clipping and filtering method, a SeLected Mapping (SLM) method, a Partial Transmit Sequence (PTS) method, and a tone reservation method.

In the clipping and filtering method, a PAPR is reduced in such a manner that a signal equal to or greater than a predetermined level is clipped from a time-domain OFDMA symbol, and, when an out-band signal is generated as a result, the out-band signal is filtered. In the SLM method and the PTS method, the PAPR of the time-domain OFDMA symbol is reduced by controlling phases of signals mapped to sub-carriers. In the SLM method, the phase is controlled in a frequency domain. In the PTS method, the phase is controlled in a time domain. In the tone reservation method, the PAPR of the OFDMA symbol is reduced by mapping dummy symbols to some sub-carriers.

Disadvantageously, however, when the clipping and filtering method is used, signal distortion may occur. When the tone reservation method is used, the dummy symbols may result in increase in transmit (Tx) signal power and also result in reduced transmission efficiency. When the SLM method and the PTS method are used, overhead occurs in exchange of controlled-phase information. Moreover, the entire OFDMA symbol may be damaged if errors occur in the controlled-phase information. Accordingly, there is a need for a method for effectively reducing a PAPR without overhead caused by additional information in an OFDMA-based broadband wireless communication system.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide an apparatus and method for reducing a Peak to Average Power Ratio (PAPR) without additional information and signal distortion in a broadband wireless communication system.

Another aspect of the present invention is to provide an apparatus and method for reducing a PAPR by controlling a phase for each group of channels which are expected to experience same propagation channel in a broadband wireless communication system.

In accordance with an aspect of the present invention, a transmitting end apparatus in a broadband wireless communication system is provided. The apparatus includes: a controller for receiving a plurality of Orthogonal Frequency Division Multiple Access (OFDMA) symbols, and for generating the same number of symbol sets corresponding to the OFDMA symbols wherein each symbol set includes a plurality of OFDMA symbols having various Peak to Average Power Ratios (PAPRs) according to several phase-shifting patterns; a selector for grouping the plurality of OFDMA symbols into symbol groups according to the same phase-shifting pattern of the several phase-shifting patterns, and for finding maximum peak value in each symbol group; and a transmitter for transmitting the symbol group having a minimum value selected from among the maximum peak values of the symbol groups.

In accordance with another aspect of the present invention, a signal transmission method of a transmitting end in a broadband wireless communication system is provided. The method includes generating a plurality of symbol sets wherein each symbol set includes a plurality of OFDMA symbols having various Peak to Average Power Ratios (PAPRs) according to several phase-shifting patterns; grouping the plurality of OFDMA symbols into symbol groups according to the same phase-shifting pattern of the several phase-shifting patterns; finding maximum peak value in each symbol group; and transmitting the symbol group having a minimum value selected from among the maximum peak values of the symbol groups.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a tile structure in a conventional broadband wireless communication system;

FIG. 2 is a block diagram of a transmitting end in a broadband wireless communication system according to an embodiment of the present invention;

FIG. 3 is a block diagram of a Peak to Average Power Ratio (PAPR) controller in a broadband wireless communication system according to an embodiment of the present invention;

FIG. 4 is a block diagram of a PAPR controller in a broadband wireless communication system according to another embodiment of the present invention;

FIG. 5 is a flowchart illustrating a PAPR reduction process performed by a transmitting end in a broadband wireless communication system according to an embodiment of the present invention;

FIG. 6 is a flowchart illustrating a PAPR control process performed by a transmitting end of a broadband wireless communication system according to an embodiment of the present invention;

FIG. 7 is a flowchart illustrating a PAPR control process performed by a transmitting end of a broadband wireless communication system according to another embodiment of the present invention; and

FIGS. 8A and 8B are graphs illustrating performance of a PAPR reduction method according to two embodiments of the present invention.

### DETAILED DESCRIPTION OF THE INVENTION

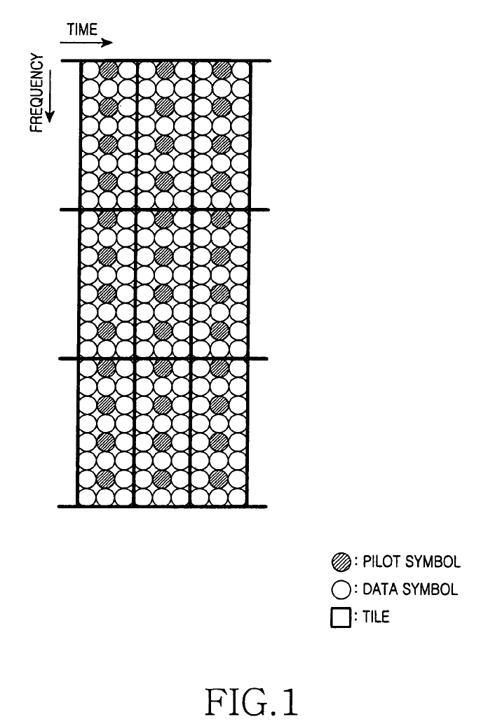

FIGS. 1 through 8B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Hereinafter, the present invention will be described which reduces a Peak to Average Power Ratio (PAPR) without additional information and signal distortion in an Orthogonal Frequency Division Multiple Access (OFDMA)-based broadband wireless communication system.

In OFDMA-based broadband wireless communication systems, a receiving end estimates a channel with respect to a transmitting end, and compensates for distortion of a receive (Rx) signal, caused by the channel, by using an estimated channel value. In this case, the receiving end estimates the channel on a tile-by-tile basis, wherein a tile is a region separated by a specific frequency-domain range and a specific time-domain range. That is, the tile is a region in which physical channels are regarded as same. One example of a tile structure is shown in FIG. 1. As shown in FIG. 1, a tile is defined as a region which includes a plurality of data symbols and a plurality of pilot symbols. The receiving end estimates the channel by using the pilot symbols included in one tile, and regards all tones within that tile as a same channel.

Therefore, even if the transmitting end arbitrarily shifts a phase on a tile-by-tile basis during transmission, it does not affect the channel estimation and symbol detection at the receiving end. In other words, when phases of the pilot symbols and the data symbols included in the tile are shifted in the same amount, the receiving end measures phase-shifting information by using the pilot symbols, and compensates for the shifted phases of the data symbols according to the measurement result and there is no need to exchange additional information on the shifted phases. Accordingly, the present invention provides a method of reducing a PAPR of an OFDMA symbol by shifting phases on a tile-by-tile basis.

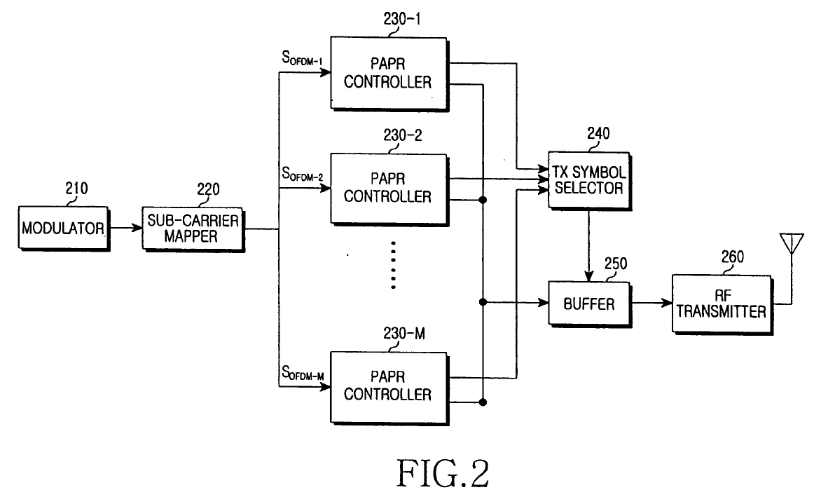

FIG. 2 is a block diagram of a transmitting end in a broadband wireless communication system according to an embodiment of the present invention.

Referring to FIG. 2, the transmitting end includes a modulator 210, a sub-carrier mapper 220, M PAPR controllers 230-1 to 230-M, a transmit (Tx) symbol selector 240, a buffer 250, and a radio-frequency (RF) transmitter 260. Herein, M denotes the number of OFDMA symbols included in one tile.

The modulator 210 converts an input bit-stream into a complex symbol by performing modulation. The sub-carrier mapper 220 maps the complex symbol provided from the modulator 210 to a sub-carrier and generates a frequency-domain OFDMA symbol. Herein, the modulator 210 outputs symbols arranged along a frequency axis as shown in FIG. 1.

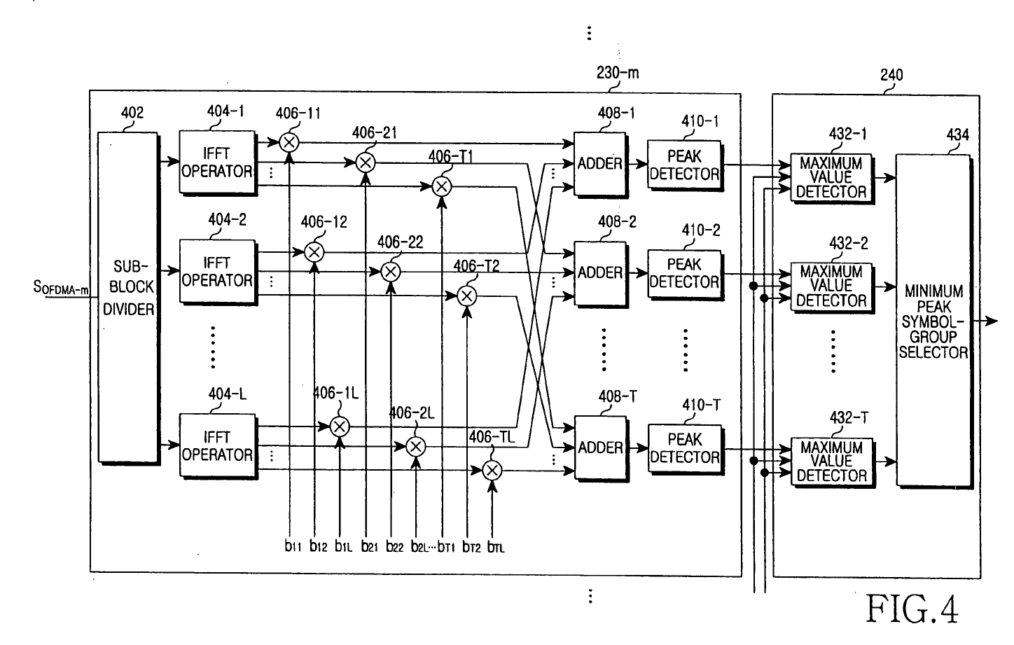

The M PAPR controllers 230-1 to 230-M receive the M frequency OFDMA symbols included in a same tile and generate M×K time-domain OFDMA symbols having K different PAPRs. That is, M PAPR controllers 230-1 to 230-M generate M OFDMA symbol sets wherein each symbol set includes K OFDMA symbols having various PAPRs according to K phase-shifting patterns. The reason of illustrating the M PAPR controllers is to show that phases of the M OFDMA symbols included in the same tile are controlled in the same manner. Thus, in practice, one PAPR controller may be used to sequentially generate time-domain OFDMA symbols having K different PAPRs with respect to the M frequency-domain OFDMA symbols. The plurality of PAPR controllers 230-1 to 230-M may be constructed in various manners according to an embodiment of the present invention. Detailed structures of the PAPR controllers 230-1 to 230-M will be described below according to two embodiments of the present invention with reference to FIG. 4.

The Tx symbol selector 240 gathers peak values of the M×K time-domain OFDMA symbols generated by the plurality of PAPR controllers 230-1 to 230-M so as to select an OFDMA symbol group having a minimum value selected from among maximum peak values of K OFDMA symbol groups which are obtained by grouping M symbols each having a phase shifted by using a same pattern, and then determines the selected OFDMA symbol group as a Tx symbol. That is, the Tx symbol selector 240 groups the plurality of OFDMA symbols into OFDMA symbol groups according to the same phase-shifting pattern of the several phase-shifting patterns. And, the Tx symbol selector 240 finds maximum peak value in each symbol group. Then, the Tx symbol selector 240 selects the OFDMA symbol group having minimum value among the maximum peak values.

The buffer 250 stores the M×K time-domain OFDMA symbols provided from the M PAPR controllers 230-1 to 230-M, and outputs the OFDMA symbols selected by the Tx symbol selector 240 to the RF transmitter 260. That is, the buffer 250 outputs the OFDMA symbol group having minimum value selected from among the maximum peak values of the symbol groups to the RF transmitter 260.

The RF transmitter 260 converts the OFDMA symbols provided from the buffer 250 into RF signals, amplifies the RF signals, and transmits the amplified RF signals through an antenna.

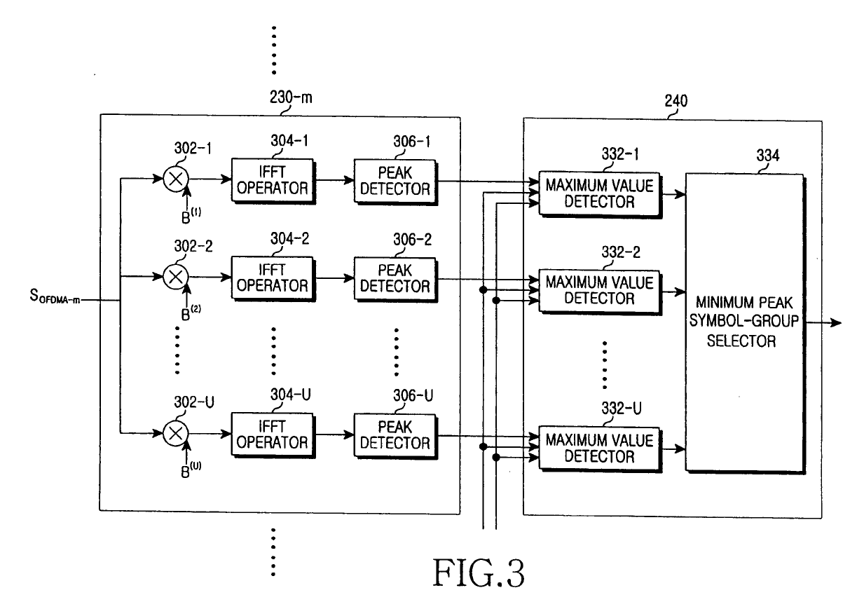

FIG. 3 is a block diagram of a PAPR controller in a broadband wireless communication system according to an embodiment of the present invention. The PAPR controller of FIG. 3 controls a phase in a frequency domain.

Referring to FIG. 3, the PAPR controller 230-m includes U multipliers 302-1 to 302-U, U Inverse Fast Fourier Transform (IFFT) operators 304-1 to 304-U, and U peak detectors 306-1 to 306-U. The Tx symbol selector 240 includes U maximum value detectors 332-1 to 332-U and a minimum peak symbol-group selector 334. Herein, U denotes the number of available phase sequences. U corresponds to K described above with reference to FIG. 2.

Each of the U multipliers 302-1 to 302-U multiplies a frequency-domain OFDMA symbol by a corresponding phase sequence B^{(u)}. The number of elements included in one phase sequence is equal to the number of sub-carriers. The elements included in a same tile on the frequency axis have a same value.

Each of the U IFFT operators 304-1 to 304-U transforms a frequency-domain OFDMA symbol, which is multiplied by a phase sequence and is provided from a corresponding multiplier, into a time-domain OFDMA symbol by performing an IFFT operation. Each of the U peak detectors 306-1 to 306-U detects a peak value of the time-domain OFDMA symbol provided from a corresponding IFFT operator.

Each of the U maximum value detectors 332-1 to 332-U finds a maximum peak value by receiving peak values of the M time-domain OFDMA symbols multiplied by corresponding phase sequences from the plurality of PAPR controllers 230-1 to 230-M. For example, the first maximum value detector 332-1 finds a maximum peak value by receiving M OFDMA symbols multiplied by a first phase sequence B(1) from the M PAPR controllers 230-1 to 230-M.

The minimum peak symbol-group selector 334 finds a minimum value selected from among the maximum peak values of the symbols provided from the U maximum value detectors 332-1 to 332-U, and selects an OFDMA symbol group corresponding to the found minimum value in order to determine a Tx symbol. The OFDMA symbol groups are stored in a buffer after outputting from a corresponding IFFT operator. When selected by the minimum peak symbol-group selector 334, the OFDMA symbol group is provided to the RF transmitter 260.

FIG. 4 is a block diagram of a PAPR controller in a broadband wireless communication system according to another embodiment of the present invention. The PAPR controller of FIG. 4 controls a phase in a time domain.

Referring to FIG. 4, the PAPR controller 230-m includes a sub-block divider 402, L IFFT operators 404-1 to 404-L, L×T multipliers 406-11 to 406-TL, T adders 408-1 to 408-T, and T peak detectors 410-1 to 410-T. The Tx symbol selector 240 includes T maximum value detectors 432-1 to 432-T and a minimum peak symbol-group selector 434. Herein, L denotes the number of sub-blocks generated from one OFDMA symbol. Further, T denotes the number of available phase-factor combinations. One phase-factor combination includes a phase factor for each of L sub-blocks. T corresponds to K described above with reference to FIG. 2.

The sub-block divider 402 divides a frequency-domain OFDMA symbol into L sub-blocks and outputs the sub-blocks to a corresponding IFFT operator. In this case, all sub-carriers included in one tile has to be included in a same sub-block. For example, when the OFDMA symbol is composed of 24 sub-carriers including three tiles as shown in FIG. 1, the sub-block divider 402 may divide the OFDMA symbol into three blocks, nullify empty sub-carriers of the three blocks, and output the sub-carriers to the L IFFT operators 404-1 to 404-L.

Each of the L IFFT operators 404-1 to 404-L transforms the frequency-domain OFDMA symbol, which is provided from the sub-block divider 402, into a time domain OFDMA symbol by performing an IFFT operation. The time-domain OFDMA symbol output from each of the L IFFT operators 404-1 to 404-L includes only signals of some sub-carriers.

Each of the L×T multipliers 406-11 to 406-TL multiplies the time-domain OFDMA symbols, which are provided from the L IFFT operators 404-1 to 404-L, by L phase factors bt1 to btL (t=1,2, . . . ,T). That is, the L multipliers 406-t1 to 406-tL are grouped into one group, and each of the L multipliers 406-t1 to 406-tL multiplies the divided time-domain OFDMA symbol provided from a corresponding IFFT operator by a corresponding phase factor. One group corresponds to one adder. The L multipliers 406-t1 to 406-tL included in a same group provide the multiplication result to a same adder.

Each of the T adders 408-1 to 408-T adds the divided time-domain OFDMA symbols, which are multiplied by one phase-factor combination, and thus generates time-domain OFDMA symbols. That is, the time-domain OFDMA symbols output from the T adders 408-1 to 408-T have different PAPRs from one another. Each of the T adders 408-1 to 408-T detects a peak value of the time-domain OFDMA symbol provided from a corresponding adder.

Each of the T adders 408-1 to 408-T finds a maximum peak value by receiving peak values of the M time-domain OFDMA symbols multiplied by corresponding phase factors from the plurality of PAPR controllers 230-1 to 230-M. For example, the first maximum value detector 432-1 finds a maximum peak value by receiving M OFDMA symbols multiplied by a first phase-factor combination (i.e., b₁₁ to b_{1L}) from the M PAPR controllers 230-1 to 230-M.

The minimum peak symbol-group selector 434 finds a minimum value selected from among respective maximum peak values of the symbols provided from the T maximum value detectors 432-1 to 432-T, and selects an OFDMA symbol group corresponding to the minimum value in order to determine a Tx symbol. The OFDMA symbol groups are stored in a buffer after outputting from a corresponding IFFT operator. When selected by the minimum peak symbol-group selector 434, the OFDMA symbol group is output and transmitted.

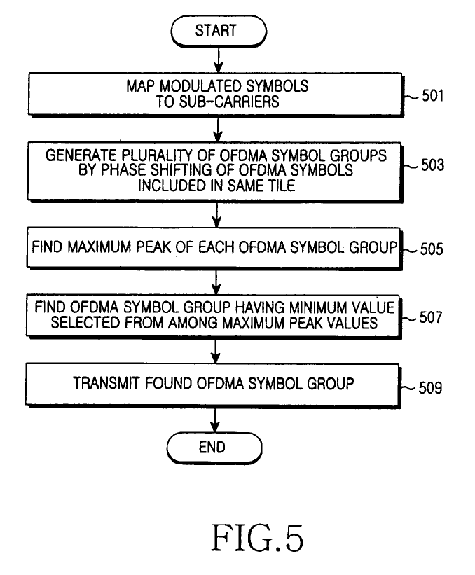

FIG. 5 is a flowchart illustrating a PAPR reduction process performed by a transmitting end in a broadband wireless communication system according to an embodiment of the present invention.

Referring to FIG. 5, modulated symbols are mapped to sub-carriers to generate a frequency-domain OFDMA symbol in step 501.

In step 503, a plurality of OFDMA symbol groups each having a different maximum peak value are generated by phase shifting of an OFDMA symbols included in a same tile on a tile-by-tile basis. In other words, an operation of generating one OFDMA symbol set including OFDMA symbols having various PAPRs according to several phase shifting patterns by using one OFDMA symbol is repeatedly performed on the plurality of OFDMA symbols included in the same tile, and thereafter PAPR-controlled OFDMA symbols are grouped by using a same phase shifting pattern to generate a plurality of OFDMA symbol groups.

In step 505, a maximum peak value of each OFDMA symbol group is found.

In step 507, an OFDMA symbol group having a minimum value selected from among the maximum peak values is found. All OFDMA symbol groups have to be stored in a buffer until the OFDMA symbol group having the minimum value selected from among the maximum peak values is found.

In step 509, the found OFDMA symbol group is transmitted.

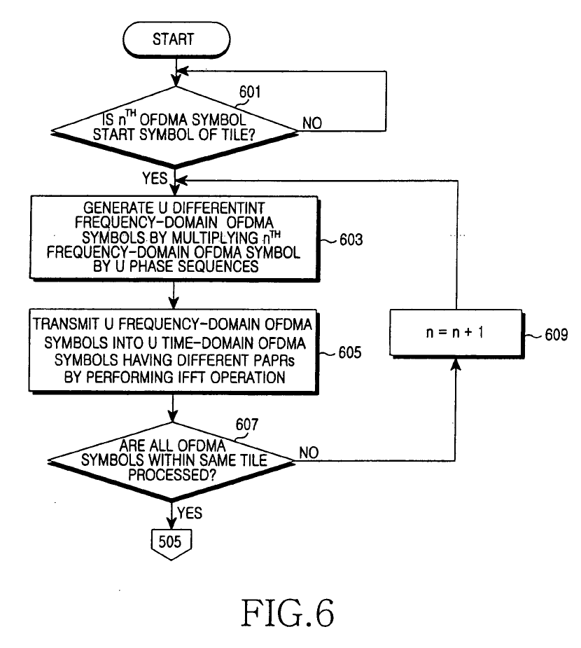

FIG. 6 is a flowchart illustrating a PAPR control process performed by a transmitting end of a broadband wireless communication system according to an embodiment of the present invention. In the process of FIG. 6, a PAPR is controlled by changing a phase in a frequency domain.

Referring to FIG. 6, it is determined if an nth OFDMA symbol is a start symbol of a tile in step 601.

If the n^{th} OFDMA symbol is the start symbol of the tile, proceeding to step 603, U different frequency-domain OFDMA symbols are generated by multiplying the n^{th} frequency-domain OFDMA symbol by U phase sequences.

In step 605, the U frequency-domain OFDMA symbols are transformed into U time-domain OFDMA symbols by performing an IFFT operation. The U time-domain OFDMA symbols have different PAPRs from one another.

In step 607, it is determined if all OFDMA symbols within a same tile are processed.

If there is any remaining OFDMA symbol included in the same tile that includes the n^{th} OFDMA symbol, proceeding to step 609, n is incremented by 1, and the procedure returns to step 603. In this case, all of the U OFDMA symbols are stored in a buffer. This is because one OFDMA symbol among the U OFDMA symbols generated from the n^{th} OFDMA symbol is transmitted after PAPR control and selection are performed on all symbols included in the tile.

On the other hand, if there is no remaining OFDMA symbol included in the same tile that includes the n^{th} OFDMA symbol, the procedure of FIG. 6 ends.

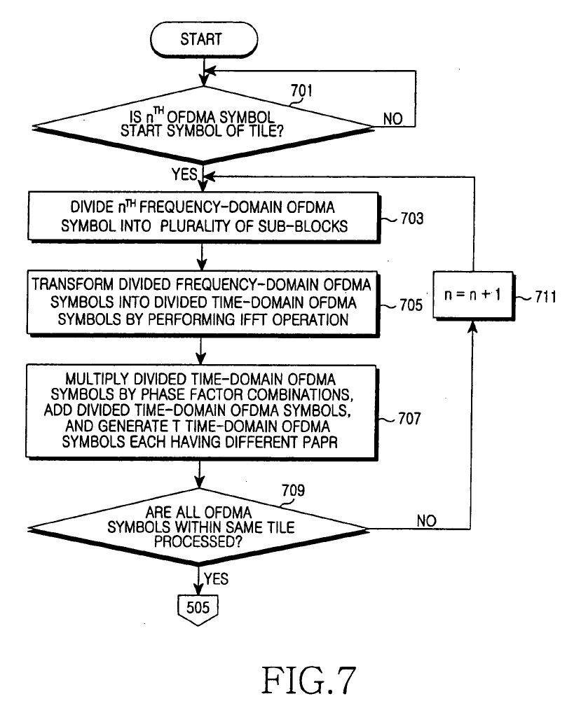

FIG. 7 is a flowchart illustrating a PAPR control process performed by a transmitting end of a broadband wireless communication system according to another embodiment of the present invention. In the process of FIG. 7, a PAPR is controlled by changing a phase in a time domain.

Referring to FIG. 7, it is determined if an n^{th} OFDMA symbol is a start symbol of a tile in step 701.

If the n^{th} OFDMA symbol is the start symbol of the tile, proceeding to step 703, the n^{th} frequency-domain OFDMA symbol is divided into a plurality of sub-blocks on a frequency axis. In this case, all sub-carriers included in one tile have to be included in a same sub-block. For convenience of explanation, it will be assumed hereinafter that the OFDMA symbol is divided into L sub-blocks.

In step 705, the divided frequency-domain OFDMA symbols are transformed into divided time-domain OFDMA symbols by performing an IFFT operation.

In step 707, the divided time-domain OFDMA symbols are multiplied by T phase-factor combinations, and the divided time-domain OFDMA symbols are added. That is, T time-domain OFDMA symbols each having a different PAPR are generated.

In step 709, it is determined if all OFDMA symbols within a same tile are processed.

If there is any remaining OFDMA symbol included in the same tile that includes the n^{th} OFDMA symbol, proceeding to step 711, n is incremented by 1, and the procedure returns to step 703. In this case, all of the T OFDMA symbols are stored in a buffer. This is because one OFDMA symbol among the T OFDMA symbols generated from the n^{th} OFDMA symbol is transmitted after PAPR control and selection are performed on all symbols included in the tile.

On the other hand, if there is no remaining OFDMA symbol included in the same tile that includes the n^{th} OFDMA symbol, the procedure of FIG. 7 ends.

The structure and operation of the transmitting end has been described with reference to the drawings. As described above, the transmitting end stores all generated OFDMA symbols and transmits the stored OFDMA symbols when a Tx symbol is determined. Such a transmission method can be used in practice when the transmitting end ensures a sufficient storage space for a plurality of OFDMA symbols. If the storage space is insufficient, the transmitting end may find a phase shifting pattern for minimizing a PAPR by using peak values of the generated OFDMA symbols, and generate a new Tx symbol by using the found phase shifting pattern.

In terms of the structure of the transmitting end, a Tx controller is required which provides control such that a phase shifting pattern used in a symbol group having a minimum value selected from among maximum peak values is found, and OFDMA symbols to be transmitted are regenerated according to the found pattern. In terms of the operation of the transmitting end, a process is required in which a phase shifting pattern used in a symbol group having a minimum value selected from among maximum peak values is found, and OFDMA symbols to be transmitted are regenerated according to the found pattern.

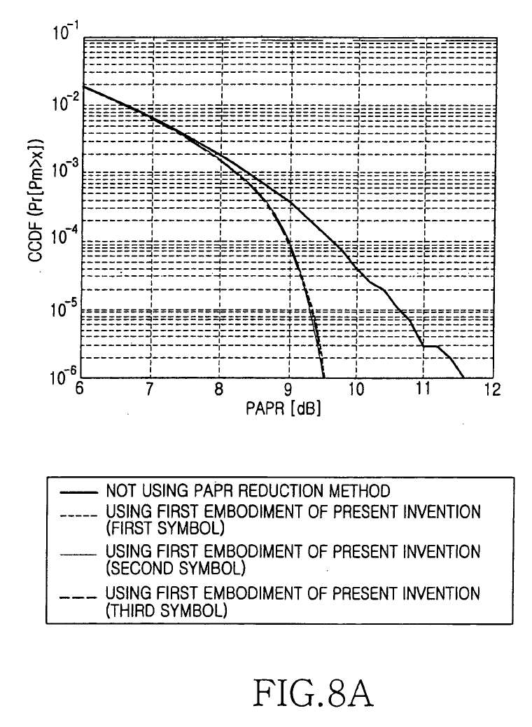

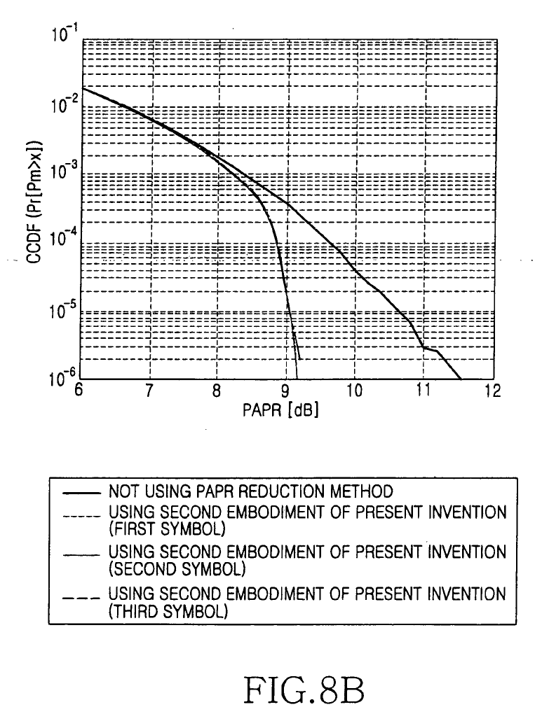

FIGS. 8A and 8B are graphs illustrating performance of a PAPR reduction method according to two embodiments of the present invention. The graphs of FIGS. 8A and 8B are obtained by performing a simulation in a system using the PAPR reduction method according to the present invention. In the simulation, the number of sub-carriers is set to 2048, the number of sub-carriers in use is set to 1920, the number of phase sequences of the first embodiment is set to 8, and the number of sub-blocks of the second embodiment is set to 6.

FIG. 8A (or FIG. 8B) shows a graph of a Complementary Cumulative Distribution Function (CCDF) with respect to a PAPR in a system using a PAPR reduction method according to a first embodiment (or a second embodiment in the case of FIG. 8B) of the present invention. The CCDF represents a probability of having a higher PAPR than a reference PAPR. The horizontal axis represents the reference PAPR, and the vertical axis represents a probability value. Referring to FIG. 8A and FIG. 8B, when the present invention is used, the probability of generating a PAPR exceeding the reference PAPR decreases when the reference PAPR increases. In addition, a threshold of a PAPR having a clipping probability of 10⁻⁶ can be reduced by about 1˜2 dB.

According to the present invention, a PAPR of a Tx signal is controlled by changing a phase for each group of tiles in a broadband wireless communication system. Therefore, the PAPR of the Tx signal can be reduced without additional information and signal distortion.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A transmitting apparatus in a wireless communication system, the apparatus comprising:
a controller for receiving a plurality of Orthogonal Frequency Division Multiple Access (OFDMA) symbols, and for generating the same number of symbol sets corresponding to the OFDMA symbols wherein each symbol set includes a plurality of OFDMA symbols having various Peak to Average Power Ratios (PAPRs) according to several phase-shifting patterns;
a selector for grouping the plurality of OFDMA symbols into symbol groups according to the same phase-shifting pattern of the several phase-shifting patterns, and for finding maximum peak value in each symbol group; and
a transmitter for transmitting the symbol group having a minimum value selected from among the maximum peak values of the symbol groups.

2. The apparatus of claim 1, wherein the controller performs a same amount phase-shifting for the sub-carriers within a region in which physical channels are regarded as same on the frequency axis.

3. The apparatus of claim 2, wherein the selector finds maximum peak value in each symbol group with respect to OFDMA symbols within a region in which physical channels are regarded as same on the time axis.

4. The apparatus of claim 3, wherein the controller comprises:
a multiplier for multiplying a frequency-domain OFDMA symbol by a phase sequence;
an operator for transforming the frequency-domain OFDMA symbol provided from the multiplier into a time-domain OFDMA symbol by performing an Inverse Fast Fourier Transform (IFFT) operation; and
a detector for detecting a peak value of the time-domain OFDMA symbol provided from the operator.

5. The apparatus of claim 3, wherein the controller comprises:
a divider for dividing the frequency-domain OFDMA symbol into a plurality of sub-blocks so that one region in which physical channels are regarded as same is included in a same sub-block;
an operator for transforming the divided frequency-domain OFDMA symbols into divided time-domain OFDMA symbols by performing an IFFT operation;
a plurality of multipliers for multiplying the divided time-domain OFDMA symbols by phase factors;
an adder for adding up the divided time-domain OFDMA symbols provided from the plurality of multipliers to generate one time-domain OFDMA symbol; and
a detector for detecting a peak value of the time-domain OFDMA symbol provided from the adder.

6. The apparatus of claim 1, further comprising:
a buffer for storing the OFDMA symbols generated by the controller and for outputting the OFDMA symbol group having minimum value selected from among the maximum peak values of the symbol groups to the transmitter.

7. The apparatus of claim 1, further comprising:
a Tx controller for providing control such that a phase-shifting pattern used in the symbol group having the minimum value selected from among maximum peak values is found, OFDMA symbols to be transmitted are regenerated according to the found pattern, and the regenerated symbols are transmitted.

8. A method of transmitting signal in a wireless communication system, the method comprising:
generating a plurality of symbol sets wherein each symbol set includes a plurality of OFDMA symbols having various Peak to Average Power Ratios (PAPRs) according to several phase-shifting patterns;
grouping the plurality of OFDMA symbols into symbol groups according to the same phase-shifting pattern of the several phase-shifting patterns;
finding maximum peak value in each symbol group; and
transmitting the symbol group having a minimum value selected from among the maximum peak values of the symbol groups.

9. The method of claim 8, wherein generating a plurality of symbol sets comprising:
performing a same amount phase-shifting for the sub-carriers within a region in which physical channels are regarded as same on the frequency axis.

10. The method of claim 9, wherein finding maximum peak value in each symbol group comprising:
finding maximum peak value in each symbol group with respect to OFDMA symbols within a region in which physical channels are regarded as same on the time axis.

11. The method of claim 10, wherein the generating a plurality of OFDMA symbols each having a different PAPR comprises:
multiplying a frequency-domain OFDMA symbol by a phase sequence; and
transforming the frequency-domain OFDMA symbol multiplied by the phase sequence into a time-domain OFDMA symbol by performing an Inverse Fast Fourier Transform (IFFT) operation.

12. The method of claim 10, wherein the generating a plurality of OFDMA symbols each having a different PAPR comprises:
dividing the frequency-domain OFDMA symbol into a plurality of sub-blocks so that one region in which physical channels are regarded as same is included in a same sub-block;
transforming the divided frequency-domain OFDMA symbols into divided time-domain OFDMA symbols by performing an IFFT operation;
multiplying the divided time-domain OFDMA symbols by phase factors; and
adding up the divided time-domain OFDMA symbols multiplied by the phase factors to generate one time-domain OFDMA symbol.

13. The method of claim 8, further comprising:
storing OFDMA symbols included in all of the plurality of OFDMA symbol groups; and
after the symbol group having a minimum value selected from among the maximum peak values of the symbol groups is selected, selecting symbols from among the stored OFDMA symbols to transmit the symbol group having a minimum value.

14. The method of claim 8, further comprising:
finding a phase-shifting pattern used in the symbol group having the minimum value selected from among the maximum peak values; and
regenerating to-be-transmitted OFDMA symbols according to the found pattern.
